(19) United States
(12) Patent Application Publication
(10) Pub. No.: US 2010/0028706 A1
(43) Pub. Date: Feb. 4, 2010

(54) SHAPED BODY

(75) Inventors: Jan Hornschu, Magdala (DE); Andre Kabis, Ottendorf (DE); Thomas Furche, Altendorf (DE); Henning Uhlerihut, Gerdau (DE)

Correspondence Address: CONNOLLY BOVE LODGE & HUTZ, LLP, P O BOX 2207, WILMINGTON, DE, 19899, US

(73) Assignee: H.C. Starck GmbH, Goslar (DE)

(21) Appl. No.: 12/535,278

(22) Filed: Aug. 4, 2009

(30) Foreign Application Priority Data
Aug. 4, 2008 (DE) 10 2008 036 070.8

(51) Int. Cl. B32B 15/01; H05H 1/24; H05H 1/48

(52) U.S. Cl. 428/577; 427/576; 427/580; 427/535; 427/540

(57) ABSTRACT

The present invention relates to blanks for workpieces composed of a base body, which comprises at least one refractory metal and an oxidation protection layer composed of at least one metal layer, and also processes for producing them.

### BACKGROUND OF THE INVENTION

Refractory metals are able to maintain their solidity up to very high temperatures. However, a problem is that these metals and alloys have only a very low resistance to oxidation when they are exposed to air or other oxidizing medium at high temperatures of above 400° C.

This is a problem because the oxide sublimes during a heat treatment and subsequent mechanical forming due to the heat of the refractory metal. The resulting smoke is not only irritating and harmful to health and therefore has to be removed, for example, by extraction but it also results in a significant loss of valuable refractory metal, which can be about 3-6% by weight.

To improve this high susceptibility to oxidation, it is known that the surface of the high-melting metals can be provided with appropriate protective layers. The application of coatings of silicides or aluminides, as disclosed in WO 98/23790, has been found to be useful for many applications.

U.S. Pat. No. 3,540,863 describes, for example, CrFe silicide layers as oxidation protection layer for a base material composed of niobium or niobium-based alloys.

Such coatings are, after application, melted on by means of a diffusing annealing treatment. This melting-on is an absolute prerequisite for homogenizing of the components of the layer and for producing the necessary barrier layer against permutation of oxygen in the case of these silicide or aluminide layers, which are nowadays applied virtually exclusively by slurry coating or plasma spraying.

However, these known coatings are all hard and brittle so that although they reduce the oxidation of the refractory metal in air and the sublimation of the oxide during a heat treatment, they are damaged during mechanical forming to such an extent that this advantageous effect no longer occurs.

### BRIEF SUMMARY OF THE INVENTION

The present invention relates, in general, to blanks for workpieces composed of a base body, which comprises at least one refractory metal and an oxidation protection layer composed of at least one metal layer, and also a process for producing them.

Various embodiments of the present invention provide blanks comprising a base body composed of a refractory metal and an oxidation protection layer, where the oxidation protection layer reduces both the oxidation during heating to the temperature necessary for hot forming and the losses due to sublimation of the oxide (vaporization losses), makes a better surface quality possible, serves as thermal insulation, is not harmful to the lining of the furnaces during heating and also adheres to the refractory metal blank and protects it during hot forming.

Various embodiments of the present invention achieve these advantages by providing a blank for a workpiece composed of a base body, which comprises at least one refractory metal and an oxidation protection layer composed of at least one metal layer.

One embodiment of the present invention is directed to a workpiece blank comprising a base body having a surface and an oxidation protection layer disposed on at least a portion of the surface, wherein the base body comprises a refractory metal and the oxidation protection layer comprises a metal.

Another embodiment of the present invention is directed to a process for producing a workpiece blank according to the various other embodiments of the invention, the process comprising:
(a) providing the base body; and
(b) applying the oxidation protection layer by a process selected from the group consisting of plasma spraying, atmospheric plasma spraying, electric arc spraying, flame spraying and cold gas spraying.

Still other embodiments of the present invention are directed to uses of a blank for a workpiece according to the various other embodiments of the invention for producing shaped bodies composed of refractory metals or alloys thereof, and to uses of plasma spraying, atmospheric plasma spraying, electric arc spraying, flame spraying or cold gas spraying for applying oxidation protection layers to refractory metals before they are subjected to heat treatment and/or mechanical forming.

It has surprisingly been found that the various embodiments of the invention not only make it possible to reduce the vaporization losses to 1% by weight or less but also make it possible for the blank for a workpiece to be hot formed for a longer time because of the insulating effect by the oxidation protection layer since the temperature required for this purpose could be held for longer, as a result of which a heat treatment step had to be carried out less often.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a refractory metal” herein or in the appended claims can refer to a single refractory metal or more than one refractory metal. Additionally, all numerical values, unless otherwise specifically noted, are understood to be modified by the word “about.”

The oxidation protection layer is advantageously free of silicides and aluminides, i.e. the content of silicides and aluminides is not more than 1% by weight.

161 For the purposes of the present invention, silicides are, in particular, silicon-based alloys containing at least 60 atom-% of Si and 5-40 atom-% of one or more elements from the group consisting of Cr, Fe, Ti, Zr, Hf, B and C, and aluminides are, in particular, aluminum-based alloys containing at least 60 atom-% of Al and 5-40 atom-% of one or more elements from the group consisting of Si, Cr, Ti, Zr, Hf, Pt, B and C.

In general, optimal matching of the coefficients of thermal expansion of base material, reaction barrier layer and oxidation protection layer will significantly increase the thermal shock resistance of the blank for a workpiece.

According to the invention, the refractory metal is selected from the group consisting of molybdenum, tungsten, tantalum, niobium and alloys thereof. Alloys of refractory metals with one another or with other metals are possible, but according to the invention the content of refractory metal has to be 50% or more.

The oxidation protection layer can, according to the invention, be applied by plasma spraying, atmospheric plasma spraying, electric arc spraying, flame spraying or cold gas spraying.

According to various embodiments of the invention, the oxidation protection layer comprises iron or an iron alloy such as steels; in particular, austenitic steels and ferritic steels are well-suited. Stainless steel is particularly advantageous,

Suitable materials for the oxidation protection layer are, for example, AlCro from Praxair having a composition of 23.5% by weight of chromium, 5.3% by weight of aluminium, 0.65% by weight of silicon and iron as balance to 100%. Wire grade Meteo 4, composition Fe 17Cr 12Ni 2.5Mo 2Mn 1Si 0.08C 0.045P 0.030S (i.e. 17% by weight of chromium, 12% by weight of nickel, 2.5% by weight of molybdenum, 2% by weight of manganese, 1% by weight of silicon, 0.08% by weight of carbon, 0.045% by weight of phosphorus, 0.030% by weight of sulphur and iron as balance to 100%) is also suitable.

The iron contents of suitable alloys are generally 3% or more, advantageously 5% or more, and preffered more than 10% or more usually from 10% to 85%, in particular from 20% to 80%, or from 25% to 71%, or from 30 to 80%, in particular from 50 to 70% or from 60 to 65%. The iron contents are usually from 60 to 80%, in particular from 60 to 70%.

Suitable iron alloys additionally contain chromium in amounts of from 10% to 30%, in particular from 15% to 25%, advantageously from 17 to 24% or from 15 to 20%.

Suitable iron alloys for the oxidation protection layer often additionally contain nickel in amounts of from 3 to 70%, in particular from 4 to 65%, advantageously from 12 to 60%, or else from 3 to 12% or from 4 to 11 %, or from 55 to 65% or from 59 to 61%.

The suitable alloys can also contain silicon in amounts of from 0.5 to 5%, advantageously from 0.6 to 1.6%, in particular from 1 to 1.5%.

Some alloys can also contain aluminium in amounts of from 0.6 to 6%, advantageously from 1 to 5.5% or from 0.8 to 1.7%, or from 4.4 to 5.3%.

The oxidation protection layer can additionally be alloyed with one or more metals from the group consisting of molybdenum, manganese, niobium, tantalum and hafinium in a proportion in each case of from 1 to 5%, advantageously from 2 to 3% or from 2 to 2.5%. The percentages designation are in each case by weight.

Particularly suitable alloys are austenitic or ferritic, iron-containing alloys which contain:
from 20 to 80% by weight of Fe;
from 14 to 24% by weight of Cr;
from 0 to 60% by weight of Ni;
up to 1.5% by weight of Si;
up to 6% by weight of Al;
up to 3% by weight of Mo;
up to 3% by weight of Mn;
less than 0.1% by weight each of C, P or S,
where the components add up to 100% by weight; or
from 20 to 80% by weight of Fe;
from 14 to 24% by weight of Cr;
from 0 to 60% by weight of Ni;
up to 1.5% by weight of Si;
from 1 to 5.5% by weight of Al;
where the components add up to 100% by weight; or
from 70 to 80% by weight of Fe;
from 17 to 24% by weight of Cr;
from 0 to 1.5% by weight of Si;
from 1 to5.5% by weight of Al;
where the components add up to 100% by weight; or
from 70 to 80% by weight of Fe;
from 17 to 24% by weight of Cr;
from 1 to 1.5% by weight of Si;
from 0.9 to 1.2% by weight or from 4.5 to 5.5% by weight of Al;
where the components add to 100% by weight; or
from 20 to 75% by weight of Fe;
from 15 to 25% by weight of Cr;
from 4 to 61% by weight of Ni;
from 0 to 1.5% by weight of Si;
where the components add up to 100% by weight; or
from 70 to 75% by weight of Fe;
from 15 to 25% by weight of Cr;
from 3 to 15% by weight of Ni;
from 0 to 1.5% by weight of Si;
where the components add to 100% by weight; or
from 20 to 75% by weight of Fe;
from 15 to 25% by weight of Cr;
from 4 to 61% by weight of Ni;
from 1 to 1.5% by weight of Si;
where the components add to 100% by weight; or
from 70 to 75% by weight of Fe;
from 15 to 25% by weight of Cr;
from 3 to 15% by weight of Ni;
from 1 to 1.5% by weight of Si;
where the components add to 100% by weight; or
from 18 to 28% by weight of Fe;
from 12 to 20% by weight of Cr;
from 50 to 65% by weight of Ni;
from 0 to 1.5% by weight of Si;
where the components add up to 100% by weight; or
from 20 to 25% by weight of Fe;
from 15 to 18% by weight of Cr;
from 58 to 63% by weight of Ni;
from 0 to 1.5% by weight of Si;
where the components add up to 100% by weight; or
from 18 to 28% by weight of Fe;
from 12 to 20% by weight of Cr;
from 50 to 65% by weight of Ni;
from 1 to 1.5% by weight of Si;
where the components add up to 100% by weight; or
from 20 to 25% by weight of Fe;
from 15 to 18% by weight of Cr;
from 58 to 63% by weight of Ni;
from 1 to 1.5% by weight of Si;
where the components add up to 100% by weight, and where these alloys can additionally contain unavoidable impurities.

The oxidation protection layer has a thickness of usually less than 5 mm, in particular from 50 μm to 1 mm, advantageously from 100 μm to 900 μm, in particular from 300 μm to 500 μm.

At least one intermediate layer can be present between the oxidation protection layer and the base body composed of the refractory metal.

The intermediate layer can be an oxide or nitride layer or a composite layer, in particular a layer composed of an oxide or nitride of the refractory metal or a composite layer composed of a refractory metal and a nonrefractory metal, in particular iron. In particular, the intermediate layer can comprise the oxides and/or nitrides of the refractory metals used for the base body.

Oxidic layers such as Y₂0₃, HfO₂, ZrO₂, La₂O₃, TiO₂,Al₂O₃ and also carbidic or nitridic layers such as HfC, TaC, NbC or Mo₂C or else TiN, HfN or ZrN are also suitable as intermediate layers. The choice of the layer system, the layer thickness, and the coating process depends firstly on the material and dimensions of the component to be protected and secondly on the use conditions.

However, the intermediate layers can also be selected according to their influence to the crystallization of the refractory metal. The intermediate layer and also the oxidation protection layer can be selected so that the refractory metal becomes microalloyed.

Possible coating processes for the deposition of the intermediate layer are in principle all known coating processes, e.g. chemical vapour deposition, physical vapour deposition or plasma spraying of powder,

Atmospheric plasma spraying of, for example, HfO₂ or ZrO₂ is advantageous. However, the intermediate layer can also be formed by reaction of previously applied components, for example carbon, with the base material to form, for example, carbides. Reactive gas phases which are suitable for converting the surface of the refractory metal in its carbide, oxide or nitride are, in particular, hydrocarbons, nitrogen or oxygen or gas mixtures containing these gases.

When the intermediate layer is composed of oxides or nitrides of the refractory metal used in the particular case, the intermediate layer can also be formed by targeted oxidation or nitriding of the surface. Oxides, suboxides or mixtures thereof can be obtained here. Possible nitrides are salt-like nitrides or else metal-like nitrides (solid solutions of nitrogen in the refractory metal), with metal-like nitrides being advantageous.

Application of an oxide layer by means of an electrochemical reaction, e.g. electrolytic oxidation, is also possible: in this way, oxide layers having a particular thickness of niobium or tantalum can be applied in a targeted manner, e.g. in an acid such as phosphoric acid and with application of a particular voltage.

The oxidation protection layer itself can likewise be deposited using all coating processes which are otherwise customary for this purpose, with the exception of pack cementation. Thermal spraying of reaction barrier layer and oxidation protection layer in immediately subsequent operations offers process engineering advantages.

The blank for a workpiece according to the invention can be used for producing shaped bodies composed of refractory metals or alloys thereof, with the blank being heated one or more times to the temperature required for hot forming and subsequently being formed by forging or rolling.

The present invention also provides a process for producing a blank for a workpiece, which comprises the steps:
Provision of a blank composed of refractory metal;
Application of the oxidation protection layer by plasma spraying, atmospheric plasma spraying, electric arc spraying, flame spraying, high-velocity flame spraying (HVOF) or cold gas spraying.

The step of provision comprises the production of refractory metal and the production of a blank by powder metallurgy or melt metallurgy. Provision additionally comprises preparation, which can comprise sawing, breaking off edges and introduction of centering. Provision advantageously further comprises surface activation, which is effected, for example, by particle blasting of the surface to a minimum roughness of Rz>40 μm, advantageously >60 μm, determined in accordance with DIN EN 4287.

Therefore, the present invention also provides a process for producing a blank for a workpiece, which comprises the steps:
Provision of a blank composed of refractory metal;
Activation of the surface, advantageously by particle blasting to a minimum roughness of Rz>40 μm, advantageously>60 μm, determined in accordance with DIN EN 4287;
Application of the oxidation protection layer by plasma spraying, atmospheric plasma spraying, electric arc spraying, flame spraying, high-velocity flame spraying (AVOF) or cold gas spraying.

The present invention also provides a process for producing a blank for a workpiece, which comprises the steps:
Provision of a blank for a workpiece as described above;
Heat treatment of the blank for a workpiece;
Mechanical forming of the blank for a workpiece;
If appropriate, repetition of heat treatment and mechanical forming;
Removal of the oxidation protection layer.

In the case of repetition of heat treatment and mechanical forming, an oxidation protection layer is advantageously reapplied before the heat treatment.

The heat treatment is generally carried out at a temperature of from 500° C. to 1500° C. advantageously from 1000° C. to 1250° C., and for a time of from 1 to 5 hours.

For the purposes of the invention, the mechanical forming is forging, rolling or extrusion.

The removal of the oxidation protection layer can be effected by cutting machining, thermal vacuum treatment or blasting with sand or metal particles, either individually or in combination with one another. Here, it is possible for the oxidation protection layer to be removed first by, for example, sandblasting and the surface subsequently to be cleaned further by turning on a lathe. The turnings formed in this way can be recycled or, for example, sold to the steel industry.

The processes of plasma spraying, atmospheric plasma spraying, electric arc spraying, flame spraying or cold gas spraying can thus be used for application of oxidation protection layers to refractory metals before the latter are subjected to heat treatment and mechanical forming.

The invention will now be described in further detail with reference to the following non-limiting examples.

### EXAMPLES

### Comparative Example 1

A molybdenum blank having a weight of about 0.7 t, a length of about 2 metres and a diameter of about 20 cm was heated at a temperature of about 1500° C. for a time of 3 hours in a gas-fired furnace. During transport from the furnace to the forging apparatus and during forging itself, severe surface oxidation and development of smoke due to sublimation of the molybdenum oxide occurred. The diameter of the blank was reduced by radial forging until further hot forming was made impossible by cooling. The blank was heated to a temperature of 1150° C. and forged two more times as described until the diameter was about 50 mm. A weight loss of molybdenum of about 21 kg (corresponding to 3%) was found.

### Example 2

A molybdenum blank having a weight of about 0.7 t, a length of about 2 metres and a diameter of about 20 cm was roughened by blasting of the surface with metal spheres (chilled cast shot) having a size of 1.2-1.6 mm in a pressure blasting apparatus using a pressure of 5 bar to a surface roughness (determined as Rz by tactile roughness measurement using a tracer needle in accordance with DIN EN 4286) Rz of about 60 μm and subsequently coated by electric arc spraying with stainless steel (wire grade Metco 4, composition Fe 17Cr 12Ni 2.5Mo 2Mn 1Si 0.08C 0.045P 0.030S) until a thickness of about half a millimetre had been reached. The blank for a workpiece obtained in this way was heated at a temperature of about 1150° C. for a time of about 180 minutes in a gas-fired furnace. During transport from the furnace to the forging apparatus, virtually no surface oxidation and only minimal formation of smoke could be observed. The diameter of the blank was reduced by radial forging until further hot forming was made impossible by cooling. During radial forging, it was observed that clusters of the applied oxidation protection layer composed of stainless steel fell off, resulting in a low to moderate degree of smoke formation and surface oxidation. To achieve the desired diameter of the blank of about 50 mm, the blank was cooled to about room temperature and the oxidation protection layer was coated with the same stainless steel by electric arc spraying. The blank was then heated to 1500° C. again and the desired diameter was achieved by radial forging. After cooling to room temperature, the oxidation protection layer was removed by blasting of the surface with metal spheres (chilled cast shot) in a pressure blasting apparatus at 5 bar as above. It was found that the required diameter of the blank of about 50 mm had been achieved. A weight loss of molybdenum of less than 7 kg (corresponding to less than 1%) was found.

### Example 3

A molybdenum blank having a weight of about 3 kg, a length of about 200 mm and a diameter of about 20 mm was roughened by blasting of the surface with metal spheres (chilled cast shot) in a pressure blasting apparatus at 5 bar to a surface roughness of about 60 μm and subsequently coated by electric arc spraying with stainless steel (wire grade Metco 4, composition Fe 17Cr 12Ni 2,.Mo 2Mn 1Si 0.08C 0.045P 0.030S) until a thickness of about half a millimetre had been reached. The blank for a shaped part obtained in this way was heated at a temperature of 1300° C. in air for a time of 6 hours in a muffle furnace. No oxidation or sublimation effect was observed.

It can be seen from a comparison of Example 2 with the comparative example that firstly the sublimation loss by forming is significantly reduced and, in addition, a heat treatment step which would have been made necessary by the insulating action of the oxidation protection layer could be saved. Example 3 shows a significantly improved oxidation resistance.

### Examples 4-8 & Comparative Examples 2-6

The procedure of Example 2 was repeated and the suitability of various coating materials was assessed. The examples are summarized in Table 1.

TABLE 1

| | | Spraying | | | Heat | |
|---|---|---|---|---|---|---|
| | Material | process | Layer thickness | Porosity | treatment | Forging |
| Example 4 | Fe18Cr1Al1Si | APS | ~250 μm | medium | good | good |
| Example 5 | X12CrNi | EAS | ~250 μm | low | good | good |
| | 25.4 | | | | | |
| Example 6 | NiFe25Cr15 | EAS | ~600 μm | medium | good | good |
| Example 7 | NiFeCr | EAS | ~500 μm | low | good | medium |

| | |
|---|---|
| Ni | 60.5% |
| Fe | 22% |
| Cr | 16% |
| Si | 1.5% |

| | | | | | | |
|---|---|---|---|---|---|---|
| | (Metco 4538) | | | | | |
| Example 8 | Fe23.5Cr5.3Al | EAS | ~500 μm | low | good | good |
| | 0.65Si | | | | | |
| | (ALCRO) | | | | | |
| Comparative | Titanium | APS | ~250 μm | high | medium | poor |
| Example 2 | (pure) | | | | | |
| Comparative | Stellite | APS | ~250 μm | medium | poor | poor |

| | | |
|---|---|---|
| Example 3 | Co | 42-53% |
| | Cr | 24-33% |
| | W | 11-22% |
| | C | 1.8-3% |

| | | | | | | |
|---|---|---|---|---|---|---|
| Comparative | X1NiCrMoNb | HVOF | ~550 μm | low | good | poor |
| Example 4 | 28 4 2 | | | | | |
| | (Steel 1.4575) | | | | | |
| Comparative | NiCrAl | APS | ~500 μm | medium | good | poor |

| | | |
|---|---|---|
| Example 5 | Ni | 76.5% |
| | Cr | 17% |
| | Al | 6% |
| | Y | 0.5% |

| | | | | | | |
|---|---|---|---|---|---|---|
| | (AMDRY 961) | | | | | |
| Comparative | ZrO2 | APS | ~600 μm | high | medium | medium |
| Example 6 | | | | | | |

Spraying processes:
APS: Atmospheric Plasma Spraying,
HVOF: High-Velocity Flame Spraying,
EAS: Electric Arc Spraying.

The titanium coating immediately becomes very brittle in air and becomes detached during forging. The Stellite layer had poor adhesion, large areas flaked off even during heat treatment and brought no improvement. The coatings used in Comparative Examples 4 and 5 become very hard very quickly during forging, as a result of which the blank can quickly no longer be forged. The zirconium dioxide layer in Comparative Example 6, on the other hand, is very brittle and flakes off.

In Example 5, an iron-containing alloy having the following composition was used:

| | |
|---|---|
| Cr | 25% |
| Nickel | 4% |
| Fe | balance to 100% |

(Steel number 1.4820 in accordance with DIN)

In Example 6, an iron-containing alloy having the following composition was used:

| | |
|---|---|
| Fe | 25% |
| Cr | 15% |
| Ni | balance to 100% |

In Example 7, an iron-containing alloy having the following composition was used:

| | |
|---|---|
| Ni | 60.5% |
| Fe | 22% |
| Cr | 16% |
| Si | 1.5% |

(Metco 4538)

In Comparative Example 3, an iron-free alloy having the following composition was used:

| | |
|---|---|
| Co | 42-53% |
| Cr | 24-33% |
| W | 11-22% |
| C | 1.8-3% |

In Comparative Example 4, an iron-free alloy having the following composition was used:

| | |
|---|---|
| Cr | 28% |
| Mo | 4% |
| Nb | 2% |
| Ni | balance to 100% |

In Comparative Example 5, an iron-free alloy having the following composition was used:

| | |
|---|---|
| Ni | 76.5% |
| Cr | 17% |
| Al | 6% |
| Y | 0.5% |

(AMDRY 961)

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention as defined by the appended claims.

What is claimed is:

1. A workpiece blank comprising a base body having a surface and an oxidation protection layer disposed on at least a portion of the surface, wherein the base body comprises a refractory metal and the oxidation protection layer comprises a metal.

2. The workpiece blank according to claim 1, wherein the oxidation protection layer comprises iron or an iron alloy.

3. The workpiece blank according to claim 1, wherein the oxidation protection layer is deposited on the surface of the base body by a process selected from the group consisting of plasma spraying, atmospheric plasma spraying, electric arc spraying, flame spraying, and cold gas spraying.

4. The workpiece blank according to claim 1, wherein the oxidation protection layer comprises an austenitic or ferritic iron alloy having an iron content of more than 3% by weight.

5. The workpiece blank according to claim 1, wherein the oxidation protection layer comprises an iron alloy having a chromium content of from 10% by weight to 30% by weight.

6. The workpiece blank according to claim 1, wherein the oxidation protection layer comprises an iron alloy having a nickel content of from 3% by weight to 70% by weight.

7. The workpiece blank according to claim 1, wherein the oxidation protection layer comprises an iron alloy having a silicon content of from 0.5% by weight to 5% by weight.

8. The workpiece blank according to claim 1, wherein the oxidation protection layer comprises an iron alloy having an aluminum content of from 0.6% by weight to 6% by weight.

9. The workpiece blank according to claim 1, wherein the oxidation protection layer comprises an iron alloy with one or more metals from the group consisting of chromium, nickel, aluminum, molybdenum, manganese, niobium, tantalum and haffnium.

10. The workpiece blank according to claim 1, wherein the refractory metal comprises one or more selected from the group consisting of molybdenum, tungsten, tantalum, niobium and alloys thereof.

11. The workpiece blank according to claim 1, farther comprising an intermediate layer disposed between the oxidation protection layer and the base body.

12. The workpiece blank according to claim 11, wherein the intermediate layer comprises a reaction barrier layer selected from the group consisting of oxides, nitrides and mixtures thereof.

13. The workpiece blank according to claim 11, wherein the intermediate layer comprises a reaction barrier layer selected from the group consisting of oxides and nitrides of the refractory metal, and mixtures thereof.

14. The workpiece blank according to claim 11, wherein the intermediate layer comprises a composite layer composed of a refractory metal and a nonrefractory metal.

15. The workpiece blank according to claim 1, the oxidation protection layer has a thickness of less than 5 mm.

16. A process for producing a workpiece blank according to claim 1, the process comprising:
(a) providing the base body; and
(b) applying the oxidation protection layer by a process selected from the group consisting of plasma spraying, atmospheric plasma spraying, electric arc spraying, flame spraying and cold gas spraying.

17. The process according to claim 16, wherein providing the base body comprises producing a blank comprising the refractory metal by powder metallurgy or melt metallurgy.

18. The process according to claim 16, further comprising:
(c) heat treating the workpiece blank;
(d) mechanical forming of the workpiece blank;
(e) optionally repeating the heat treating and mechanical forming one or more times; and
(f) removing the oxidation protection layer.

19. The process according to claim 18, wherein the heat treating and mechanical forming are repeated at least once, and further comprising re-applying an oxidation protection layer prior to the at least one repetition.

20. The process according to claim 18, wherein heat treating is carried out at a temperature of 500° C. to 1500° C. for 1 to 5 hours.

21. The process according to claim 18, wherein the mechanical forming comprises forging, rolling or extrusion.

22. The process according to claim 18, wherein removing the oxidation protection layer comprises cutting machining, thermal vacuum treatment or blasting with sand or metal particles.
